(19) United States
(12) Patent Application Publication
(10) Pub. No.: US 2018/0143766 A1
(43) Pub. Date: May 24, 2018

(54) FAILURE PROTECTION COPY MANAGEMENT

(71) Applicant: International Business Machines Corporation, Armonk, NY (US)

(72) Inventors: Theresa M. Brown, Tucson, AZ (US); Nedlaya Y. Francisco, Tucson, AZ (US); Lisa J. Gundy, Tucson, AZ (US); Jeffrey R. Suarez, Tucson, AZ (US)

(21) Appl. No.: 15/355,250

(22) Filed: Nov. 18, 2016

(51) Int. Cl. G06F 3/06

(52) U.S. Cl. CPC G06F 3/065; G06F 3/0619; G06F 11/2069; G06F 3/067; G06F 3/0644

(57) ABSTRACT

The method includes determining a state of a local storage volume variable. The method also includes executing a local relation-withdraw command if the local storage volume variable is in a ready-to-remove state. The method also includes sending a copy command to a remote storage volume and setting the local storage volume variable to a remove-pending state if the local storage volume variable is not set to ready-to-remove. The method also includes executing a local relation-withdraw command after a notification from the remote storage volume that the remote copy operation is complete and if the local storage volume variable is in the remove-pending state. The method also includes setting the local storage volume variable to ready-to-remove after notification from the remote storage volume that the remote copy operation at the remote storage volume is complete and if the local storage volume variable is not set to the remove-pending state.

### FIELD

The subject matter disclosed herein relates to failure protection and more particularly relates to failure protection copy management.

### BACKGROUND

Customers of data storage systems rely upon uninterrupted access. Datasets undergo updates both in hardware and software as well as failures in hardware and software, and other interruptions that may prevent customer access. Data storage systems provide multiple location storage strategies to provide constant access and failure protection. Disk mirroring is one approach to provide system availability and protection against disk failures, data corruption, or other failures which may interrupt access. Keeping copies of the data on separate storage systems allows a system to continue to operate in the event of an interruption such as a failure, update, backup or other occurrence. Geographic mirroring is a function that keeps the copies of the data at geographically separate sites to provide high availability and failure recovery. One site may be designated as a primary or local site while the other is designates as a backup or remote site. The data on the local site may be used as a production or original dataset while the data maintained on the remote site is a mirror copy of the original dataset.

### BRIEF SUMMARY

A redundant storage management system is disclosed. The system includes a local copy manager, a remote copy manager, and a relations manager. The local copy manager is coupled to a local storage volume. The local storage volume includes an original dataset. The local copy manager maintains a local copy of the original data set on the local storage volume. The remote copy manager is coupled to a remote storage volume. The remote copy manager maintains a remote mirror of the original dataset on the remote storage volume. The remote copy manager also maintains a remote copy of the remote mirror on the remote storage volume. The relations manager is coupled to the local storage volume and the remote storage volume. The relations manager sends a withdraw-relation command to the remote storage volume in response to a determination that a copy operation for the local copy on the local storage volume has been executed. The relations manager executes the withdraw-relation command on the local storage volume in response to a notification from the remote storage volume that the withdraw-relation command has been executed on the remote storage volume. At least a portion of the local copy manager, the remote copy manger, and the relations manager includes one or more of hardware and executable code, the executable copy stored on one or more computer readable storage media.

A method is disclosed. The method includes determining a state of a local storage volume variable describing a copy status of an original dataset and a corresponding local copy both stored on a local storage volume. The method also includes executing a relation-withdraw command at the local storage volume in response to a determination that the local storage volume variable is in a ready-to-remove state. The method also includes sending a command to a remote storage volume to execute a copy operation and setting the local storage volume variable to a remove-pending state in response to a determination that the local storage volume variable is not in the ready-to-remove state. The method also includes executing a relation-withdraw command at the local storage volume in response to receipt of a notification from the remote storage volume indicating that the copy operation at the remote storage volume is complete and a determination that the local storage volume variable is set to the remove-pending state. The method also includes setting the local storage volume variable to the ready-to-remove state in response to receipt of the notification from the remote storage volume indicating that the copy operation at the remote storage volume is complete and a determination that the local storage volume variable is not set to the remove-pending state.

A computer program product is also described. The computer program product includes a computer readable storage medium having program instructions embodied therewith. The program instructions are readable/executable by a processor to cause the processor to determine a state of a local storage volume variable describing a copy status of an original dataset and a corresponding local copy both stored on a local storage volume. The program instructions also cause the processor to execute a relation-withdraw command at the local storage volume in response to a determination that the local storage volume variable is in a ready-to-remove state. The program instructions also cause the processor to send a command to a remote storage volume to execute a copy operation and set the local storage volume variable to a remove-pending state in response to a determination that the local storage volume variable is not is the ready-to-remove state. The program instructions also cause the processor to execute a relation-withdraw command at the local storage volume in response to receipt of a notification from the remote storage volume indicating that the copy operation at the remote storage volume is complete and a determination that the local storage volume variable is set to the remove-pending state. The program instructions also cause the processor to set the local storage volume variable to the ready-to-remove state in response to receipt of the notification from the remote storage volume indicating that the copy operation at the remote storage volume is complete and a determination that the local storage volume variable is not set to the remove-pending state.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a redundant storage management system in accordance with one embodiment of the present invention;

FIG. 2 is a schematic block diagram illustrating another embodiment of the redundant storage management system of FIG. 1 in accordance with one embodiment of the present invention;

FIG. 3 is a schematic block diagram illustrating another embodiment of a redundant storage management system in accordance with one embodiment of the present invention; and

FIG. 4 is a schematic flow chart diagram illustrating one embodiment of a method of relation withdrawal in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The computer program product may be deployed by manually loading directly in the client, server and proxy computers via loading a computer readable storage medium such as a CD, DVD, etc., the computer program product may be automatically or semi-automatically deployed into a computer system by sending the computer program product to a central server or a group of central servers. The computer program product is then downloaded into the client computers that will execute the computer program product. Alternatively, the computer program product is sent directly to the client system via e-mail. The computer program product is then either detached to a directory or loaded into a directory by a button on the e-mail that executes a program that detaches the computer program product into a directory. Another alternative is to send the computer program product directly to a directory on the client computer hard drive. When there are proxy servers, the process will, select the proxy server code, determine on which computers to place the proxy servers' code, transmit the proxy server code, then install the proxy server code on the proxy computer. The computer program product will be transmitted to the proxy server and then it will be stored on the proxy server.

The computer program product, in one embodiment, may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely, parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

The computer program product, in one embodiment, may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the computer program product (i.e. the software resides elsewhere) wherein the lifetime of the VPN is limited to a given period of time or a given number of deployments based on an amount paid.

The computer program product may be deployed, accessed and executed through either a remote-access or a site-to-site VPN. When using the remote-access VPNs the computer program product is deployed, accessed and executed via the secure, encrypted connections between a company's private network and remote users through a third-party service provider. The enterprise service provider (ESP) sets up a network access server (NAS) and provides the remote users with desktop client software for their computers. The telecommuters can then dial a toll-free number or attach directly via a cable or DSL modem to reach the NAS and use their VPN client software to access the corporate network and to access, download and execute the computer program product.

When using the site-to-site VPN, the computer program product is deployed, accessed and executed through the use of dedicated equipment and large-scale encryption that are used to connect a company's multiple fixed sites over a public network such as the Internet.

The computer program product is transported over the VPN via tunneling which is the process of placing an entire packet within another packet and sending it over a network. The protocol of the outer packet is understood by the network and both points, called tunnel interfaces, where the packet enters and exits the network.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

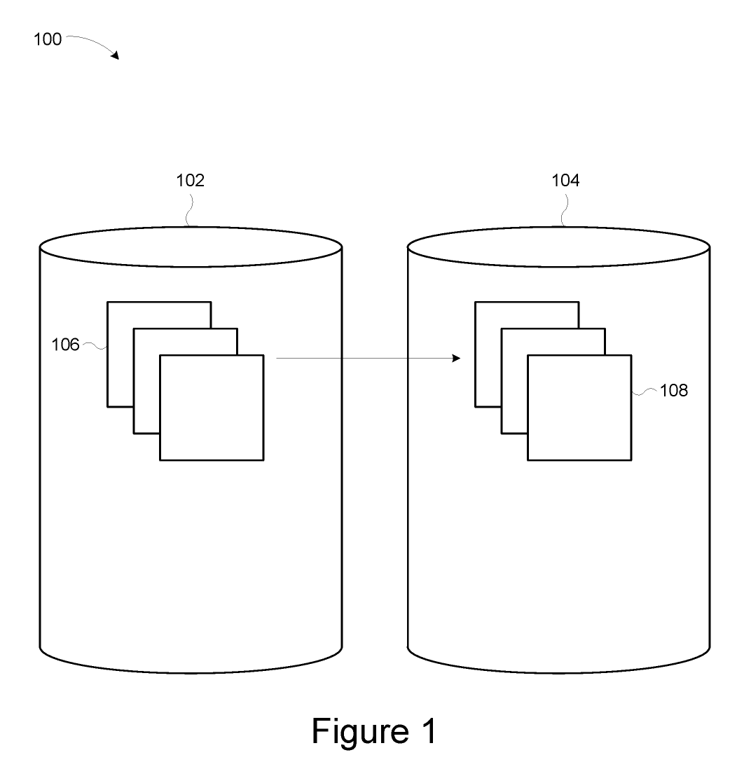

FIG. 1 is a schematic block diagram illustrating one embodiment of a redundant storage management system 100 in accordance with one embodiment of the present invention. In the illustrated embodiment, the redundant storage management system 100 includes a local storage volume 102 and a remote storage volume 104. The local storage volume 102 includes an original dataset 106 and the remote storage volume 104 includes a remote mirror 108.

In some embodiments, the local storage volume 102 and the remote storage volume 104 are logical volumes. In some embodiments, the remote storage volume 104 is isolated from the local storage volume 102. For example, the remote storage volume 104 may be geographically separated from the local storage volume 102. In another example, the remote storage volume 104 may be isolated from the power source of the local storage volume 102 such that a power failure to the local storage volume 102 would not affect the remote storage volume 104. Other examples may include other manners of isolating the local storage volume 102 from the remote storage volume 104. In some embodiments, the local storage volume 102 and the remote storage volume 104 are coupled in an initial state of simplex in which the local storage volume 102 and the remote storage volume 104 are not yet paired for copy operations. As used herein, the term “coupled” refers to a connection that may be direct or indirect. Coupling may be achieved through intermediate components or connections. Components may be coupled via network connectivity which may include wired or wireless communication.

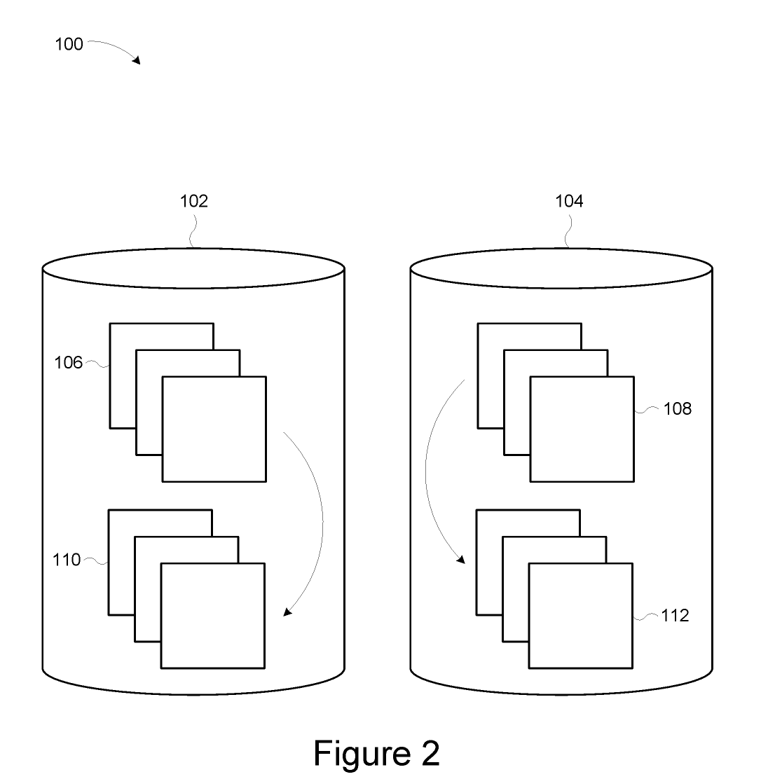

Once the local storage volume 102 is paired with the remote storage volume 104, the volumes 102 and 104 are in a pending state. In some embodiments, during the pending state, the original dataset 106 is copied from the local storage volume 102 and sent to the remote storage volume 104 to be stored as the remote mirror 108. In another embodiment, the original dataset 106 is copied locally to form a local copy (i.e. local copy 110 of FIG. 2). The local copy 110 is then copied from the local storage volume to the remote storage volume 104 to form the remote mirror 108. Other copy orders or strategies may be implemented.

Once creation or updating of the remote mirror 108 is complete, the local storage volume 102 and the remote storage volume 104 enter a duplex state in which the volumes are fully synchronized. Changes made to the original dataset 106 are also made at the remote mirror 108 to maintain consistency of data and full synchronization or duplex.

FIG. 2 is a schematic block diagram illustrating another embodiment of the redundant storage management system 100 of FIG. 1 in accordance with one embodiment of the present invention. In the illustrated embodiment, the remote mirror 108 has been created on the remote storage volume 104. In some embodiments, the original data set 106 is also copied to form a local copy 110 on the local storage volume 102. The remote mirror 108 or the local copy 110 may be created through a single copy operation or through an incremental copy operation in which portions of the original dataset 106 are copied separately.

Similarly, a remote copy 112 is formed on the remote storage volume 104. In some embodiments, the remote copy 112 is created by copying the remote mirror 108. In the illustrated embodiment, the original dataset 106 and the remote mirror 108 form a full duplex pair while the local copy 110 forms a full duplex pair with the remote copy 112. Additionally, in some embodiments, the original dataset 106 is linked by a relation with the local copy 110 and the remote mirror 108 is linked by a relation to the remote copy 112. The relation may be established during an update or copy operation or in response to another trigger event.

Operations such as copy, backup, defragmentation, and other may happen on a frequent or non-frequent, scheduled or unscheduled basis. In some embodiments, the data from the original copy 106 and the local copy 110 may be stored at random or assigned locations within the local storage volume 102. In some embodiments, the data from the original dataset 106 may be mixed with data from the local copy 110. In some embodiments, the data from the original dataset 106 and the local copy 110 may be stored based on a disk space efficiency plan and/or another storage plan. The data of the remote mirror 108 and the remote copy 112 may be stored in a similar or unique manner on the remote storage volume 104.

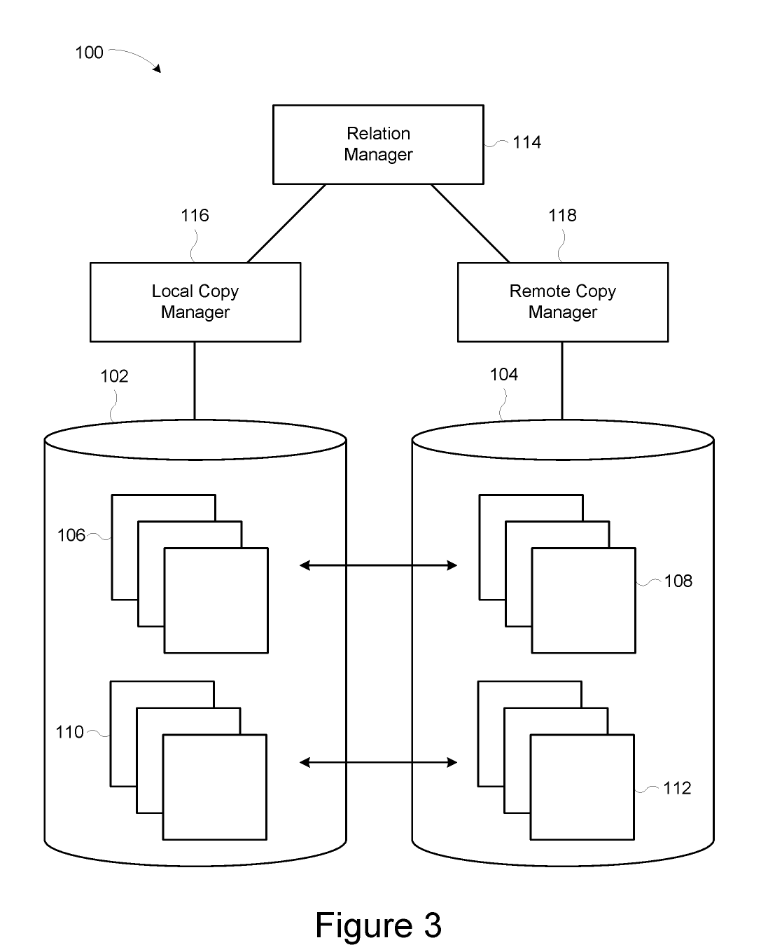

By copying the original dataset 106 to create the local copy 110 and copying the remote mirror 108 to create the remote copy 112, the movement of data from the local storage volume 102 to the remote storage volume 104 is reduced. In particular, instead of copying the original dataset 106 or the local copy 110 from the local storage volume 102 to create the remote copy 112, the remote copy is created as a copy of the remote mirror 108. The copy operations are discussed in greater detail below with reference to FIG. 3.

FIG. 3 is a schematic block diagram illustrating another embodiment of a redundant storage management system 100 in accordance with one embodiment of the present invention. The illustrated embodiment includes a relation manager 114, a local copy manager 116, a remote copy manager 118, a local storage volume 102, and a remote storage volume 104.

In some embodiments, the relation manager 114 is in communication with the local storage volume 102 and the remote storage volume 104. The relation manager 114 establishes the relations between data on the local storage volume 102 and the remote storage volume 104. In some embodiments, the relation manager 114 establishes command links between the storage volumes 102 and 104. For example, the relation manager 114 may receive a relationship-establish command (i.e. from a host) and send the relationship-establish command to the local storage volume 102 and also send a relationship-establish in-band command to the remote storage volume 104. Over the same or a different link, the remote copy manager 118 may receive an in-band copy command to initiate a copy operation on the remote mirror 108 to create or update the remote copy 112. In some embodiments, the link established by the relation manager 114 eliminates the need for a host connection from the local storage volume 102 to the remote storage volume 104. In one embodiment, if the relation manager 114 determines that the remote storage volume is compromised or does not meet configuration requirements, the relation manager 114 may ignore the remote storage volume 104 and issue copy operation commands to the local storage volume 102 only without allowing commands across to the remote storage volume. Alternatively, if the local storage volume 102 does not meet configuration requirements, the relation manager 114 may treat the local storage volume 102 as a standalone storage volume.

In some embodiments, the relation manager 114 places the system 100 in a duplex-pending state while changes made to the original dataset 106 of the local storage volume 102 are made at the remote mirror 108 and then regain full duplex. In other embodiments, the relation manager 114 maintains a duplex state of the system 100 during an update or copy process. In some embodiments, the time period to execute the update or copy operations depends on the amount of data being copied and the available resources (processor speed, memory availability and speed, etc.). In some embodiments, the relation manager 114 may maintain continuous dataset access through normally interruptive operations such as backup, update, defragmentation, etc.

In some embodiments, the relation manager 114 also includes fail-safes. For example, if the relation manager 114 sends an in-band copy command to the remote storage volume 104 and does not receive a notification from the remote storage volume 104 that the copy command was executed and the copy relation withdrawn, the relation manager 114 may initiate a timer. In response to an expiration of the timer, the relation manager 114 may execute a relation-withdraw command on the local storage volume 102. In some embodiments, the relation manger 114 may monitor one or more variables corresponding with the relations on the local storage volume 102 and the remote storage volume 104. The relation manager 114 may perform fewer or other tasks or functions.

The local copy manager 116 may include microcode or other protocol to execute operations on the local storage volume 102. For example, the local copy manager 116 may receive a copy command. In response to the copy command, the local copy manager 116 may copy the original dataset 106 to create the local copy 110. The local copy manager 116 may also establish and maintain a local relation between the original dataset 106 and the local copy 110. In response to establishing the local relation between the original data set 106 and the local copy 110, the local copy manager 116 may establish a relation link with one or more of the remote mirror 108 or the remote copy 112 of the remote storage volume 104. In other embodiments, the local copy manager 116 may notify the relation manager 114 in response to establishing the local relation with the original dataset 106 and the local copy 110 on the local storage volume 102. The relation manager 114 may initiate the relation link between the local storage volume 102 and the remote storage volume 104 upon a determination that the local relation is established.

Similar to the description above, relating to the local copy manager 116, the remote copy manager 118 includes microcode to execute operations to manage the remote storage volume 104. The remote copy manager 118 receives commands from the relation manager 114 and/or the local copy manager 116. For example, in one embodiment, the remote copy manager 118 receives in-band commands to establish relations, perform copies, and withdraw relations. By operating on commands instead of transferring data from the local storage volume 102 to the remote storage volume 104, the remote copy manager 118 allows for a reduction in traffic between the volumes 102 and 104 and less reliance on network stability and speed. This reduces resource loads, potential downtime, and potential failures. In some embodiments, the relation manager 114 executes a withdraw-relation command. The withdraw-relation command is described in greater detail below.

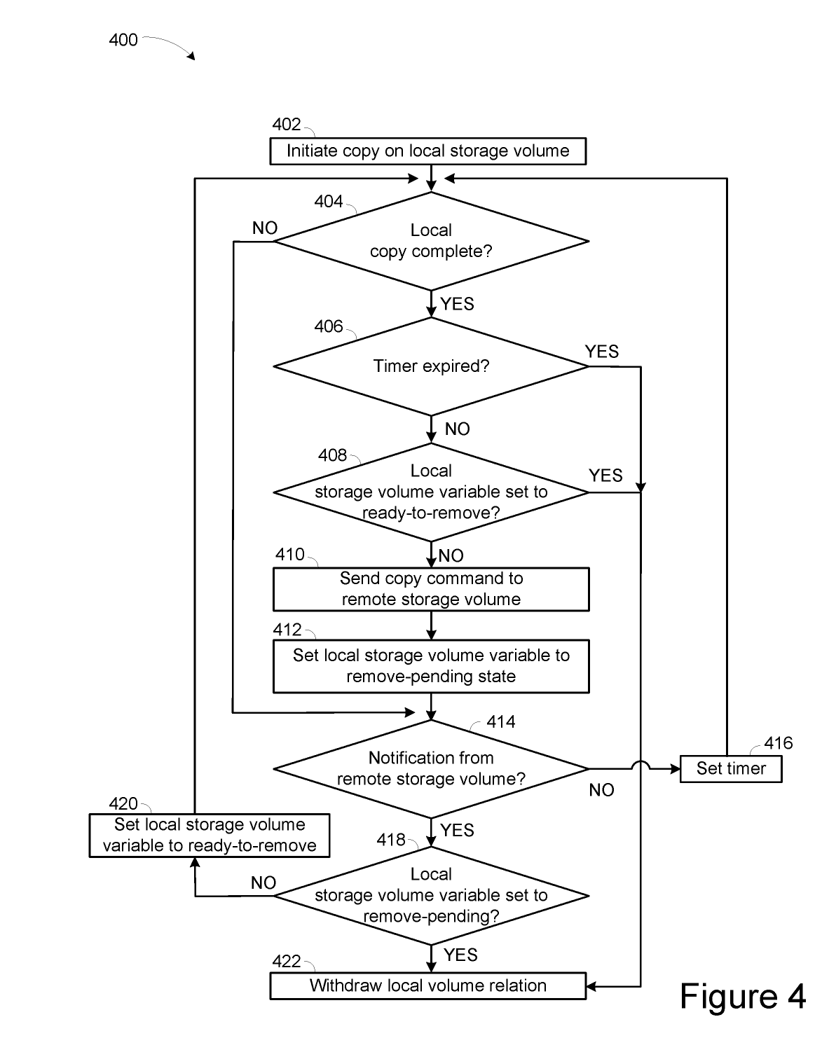

FIG. 4 is a schematic flow chart diagram illustrating one embodiment of a method 400 of relation withdrawal in accordance with one embodiment of the present invention. In the illustrated embodiment, the method 400 starts, at block 402, in which a copy operation run on the original dataset is initiated. In some embodiments, the original dataset resides on the local storage volume, as described above with reference to FIGS. 1-3. In some embodiments, the copy operation may be initiated in response to an automated system such as an update scheduler, in response to a change made at the original dataset, a manual update command, or in response to satisfaction of another criterion.

At block 404, the status of the copy operation is checked. If the local copy operation is complete, the status of a timer is checked at block 406. If the local copy is not complete, the method 400 advances to block 414, which is discussed below. If the timer, at block 406, is expired, the method 400 advances to block 422 and the local volume relation is withdrawn. If the timer has not expired or has not been set, the status of the local storage volume variable is checked at block 408. If the local storage volume variable is set to a ready-to-remove state, the local volume relation is withdrawn at block 422. If the local storage volume variable is not set to ready-to-remove at block 408, then a copy command is sent to the remote storage volume at block 410. In some embodiments, the copy command sent to the remote storage volume is an in-band command sent to the remote copy manager and executed by copying the remote mirror to create or update the remote copy, as described above with respect to FIG. 3. At block 412, the local storage volume variable is set to a remove-pending state.

At block 414, the method 400 includes a check for a notification from the remote storage volume. The notification includes an indicator that the copy command sent to the remote storage volume has been completed and the relation on the local storage volume may be withdrawn. If the notification has been received from the remote storage volume, at block 414, a check is made, at block 418, to verify the value of the local storage volume variable. If the notification has not been received from the remote storage volume, the timer is initiated at block 416. The timer may be set for any preset amount of time or for an amount of time determined by one or more variables such as current predicted processor load, memory load, network traffic, or other factors.

If the local storage volume variable is set to a remove-pending state, the local volume relation is withdrawn at block 422. If the local storage volume variable is not determined to be set to a remove-pending state at block 418, the local storage volume variable is set to a ready-to-remove state, at block 420, and the method 400 returns to block 404.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A redundant storage management system comprising:
a local copy manager that is coupled to a local storage volume, the local storage volume comprising an original dataset, wherein the local copy manager maintains a local copy of the original dataset on the local storage volume;
a remote copy manager that is coupled to a remote storage volume and maintains a remote mirror of the original dataset on the remote storage volume and maintains a remote copy of the remote mirror on the remote storage volume; and
a relations manager that is coupled to the local storage volume and the remote storage volume and that sends a withdraw-relation command to the remote storage volume in response to a determination that a copy operation for the local copy on the local storage volume has been initiated and that executes the withdraw-relation command on the local storage volume in response to a notification from the remote storage volume that the withdraw-relation command has been executed on the remote storage volume;
wherein at least a portion of the local copy manager, the remote copy manager, and the relations manager comprises one or more of hardware and executable code, the executable code stored on one or more computer readable storage media.

2. The system of claim 1, wherein the relations manager further sets a failsafe timer and executes the withdraw-relation command on the local storage volume in response to an expiration of the failsafe timer.

3. The system of claim 1, wherein the original dataset and the remote mirror are full duplex synchronized and the local copy and remote copy are full duplex synchronized.

4. The system of claim 1, wherein the withdraw-relation command is an in-band command sent to the remote storage volume.

5. The system of claim 1, wherein the relations manager sets a local storage volume variable to a remove-pending state in response to completion of the copy operation.

6. The system of claim 1, wherein the relations manager sets a local storage volume variable to a ready-to-remove state in response to the notification, from the remote storage volume, that the withdraw-relation command has been executed on the remote storage volume and in response to the local storage volume variable not being in a remove-pending state.

7. The system of claim 1, wherein the local storage volume is at a location separate from the remote storage volume.

8. A method comprising:
determining a state of a local storage volume variable describing a relation status of an original dataset and a corresponding local copy both stored on a local storage volume;
executing a relation-withdraw command at the local storage volume in response to a determination that the local storage volume variable is in a ready-to-remove state;
sending a command to a remote storage volume to execute a copy operation and setting the local storage volume variable to a remove-pending state in response to a determination that the local storage volume variable is not in the ready-to-remove state;
executing a relation-withdraw command at the local storage volume in response to receipt of a notification from the remote storage volume indicating that the copy operation at the remote storage volume is complete and a determination that the local storage volume variable is set to the remove-pending state; and
setting the local storage volume variable to the ready-to-remove state in response to receipt of the notification from the remote storage volume indicating that the copy operation at the remote storage volume is complete and a determination that the local storage volume variable is not set to the remove-pending state.

9. The method of claim 8, further comprising setting a timer to trigger the relation-withdraw command after a set amount of time and in an absence of the notification from the remote storage volume.

10. The method of claim 8, wherein the remote storage comprises:
a remote mirror that is duplex synchronized with the original dataset on the local storage volume; and
a remote copy that is duplex synchronized with the local copy.

11. The method of claim 10, wherein the remote mirror is generated by copying the original dataset from a first local location within the local storage volume to a first remote location within the remote storage volume, the original copy is generated by copying the original dataset from the first local location within the local storage volume to a second local location within the local storage volume, the remote copy is generated by copying the remote mirror from the first remote location within the remote storage volume to a second remote location within the remote storage volume.

12. The method of claim 11, wherein at least one of the remote mirror, the local copy, and the remote copy is a point-in-time copy.

13. The method of claim 11, wherein at least one of the remote mirror, the local copy, and the remote copy is a synchronous copy.

14. The method of claim 8, wherein executing the relation-withdraw command comprises:
identifying a relationship on the local or remote storage volume based on the relation-withdraw command; and
process the identified relationship.

15. The method of claim 8, wherein sending the command to the remote storage volume to execute the copy operation comprises sending an in-band command to reduce network traffic.

16. The method of claim 8, wherein the relation-withdraw command comprises a parameter describing a target storage volume or target portion of the target storage volume.

17. A computer program product for providing product support, the computer program product comprising a computer readable storage medium having program instructions embodied therewith, the program instructions readable/executable by a processor to cause the processor to:
determine, by the processor, a state of a local storage volume variable describing a copy status of an original dataset and a corresponding local copy both stored on a local storage volume;
execute, by the processor, a relation-withdraw command at the local storage volume in response to a determination that the local storage volume variable is in a ready-to-remove state;
send, by the processor, a command to a remote storage volume to execute a copy operation and set the local storage volume variable to a remove-pending state in response to a determination that the local storage volume variable is not is the ready-to-remove state;
execute, by the processor, a relation-withdraw command at the local storage volume in response to receipt of a notification from the remote storage volume indicating that the copy operation at the remote storage volume is complete and a determination that the local storage volume variable is set to the remove-pending state; and
set, by the processor, the local storage volume variable to the ready-to-remove state in response to receipt of the notification from the remote storage volume indicating that the copy operation at the remote storage volume is complete and a determination that the local storage volume variable is not set to the remove-pending state.

18. The computer program product of claim 17, wherein the program instructions are further to cause the processor to set a timer to trigger the relation-withdraw command after a set amount of time and in an absence of the notification from the remote storage volume.

19. The computer program product of claim 17, wherein the program instructions are further to cause the processor to monitor a synchronization state of the local storage volume and the remote storage volume.

20. The computer program product of claim 17, wherein the local storage volume comprises a plurality of storage devices at a local storage location.
